(19) United States
(12) Patent Application Publication
(10) Pub. No.: US 2024/0338330 A1
(43) Pub. Date: Oct. 10, 2024

(54) APPARATUS AND METHOD FOR SUPPORTING DATA INPUT/OUTPUT OPERATION BASED ON A DATA ATTRIBUTE IN A SHARED MEMORY DEVICE OR A MEMORY EXPANDER

(71) Applicant: SK hynix Inc., Gyeonggi-do (KR)

(72) Inventor: Sung Hyun HONG, Gyeonggi-do (KR)

(21) Appl. No.: 18/458,154

(22) Filed: Aug. 30, 2023

(30) Foreign Application Priority Data
Apr. 4, 2023 (KR) 10-2023-0044005

(51) Int. Cl. G06F 13/16; G06F 13/42

(52) U.S. Cl. CPC G06F 13/1673; G06F 13/1689; G06F 13/4221

(57) ABSTRACT

A data processing system includes a plurality of memory devices including a first memory device and a second memory device, and a fabric instance including a buffer. The fabric instance is configured to receive write data including first data and second data from the at least one host; store the second data in the buffer; transfer the first data to the first memory device; and transfer the second data from the buffer to the second memory device at a preset timing after transferring the first data.

### CROSS-REFERENCE TO RELATED APPLICATIONS

This patent application claims the benefit of priority under 35 U.S.C. § 119 (a) to Korean Patent Application No. 10-2023-0044005, filed on Apr. 4, 2023, the entire disclosure of which is incorporated herein by reference.

### TECHNICAL FIELD

One or more embodiments of the present disclosure described herein relate to a memory device, and more particularly, to an apparatus and a method for controlling a data input/output operation in a shared memory device, or a memory expander, coupled as an external device to a plurality of computing devices.

### BACKGROUND

The amount of computation in a computing system increases in response to a user's needs. Due to the increase in the amount of computation, the amount of data generated or stored in storage is also increasing. While the amount of data increases, the space for storing data in the computing system might be limited. A memory expander, or a shared memory device, could be used to store a significant amount of data and avoid degradation in computing power and performance of the computing system. The memory expander can be understood as a composable infrastructure to overcome resource limitations in the computing system. If the computing system and the memory expander perform high-speed data communication, they could support the operation of high-intensity workloads that occur in fields of big data and machine learning.

### BRIEF DESCRIPTION OF THE DRAWINGS

The description herein makes reference to the accompanying drawings wherein like reference numerals refer to like parts throughout the figures.

FIG. 1 describes an example of a data processing system according to an embodiment of the present disclosure.

FIG. 2 describes an operation of a data processing system according to an of the present disclosure.

FIG. 3 describes configuration of network fabric in a data processing system according to an embodiment of the present disclosure.

FIG. 4 describes an example of a Compute Express Link (CXL) switch according to an of the present disclosure.

FIG. 5 describes a scheduler according to an embodiment of the present disclosure.

FIG. 6 describes an operation of a scheduler according to an embodiment of the present disclosure.

FIG. 7 illustrates a first example of data input/output operations performed in a data processing system according to an embodiment of the present disclosure.

FIG. 8 illustrates a second example of data input/output operations performed in a data processing system according to an embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. Examples of block/unit/circuit/component used with the “configured to” language include hardware, circuits, memory storing program instructions executable to implement the operation, etc. Additionally, “configured to” can include a generic structure, e.g., generic circuitry, that is manipulated by software and/or firmware, e.g., a FPGA or a general-purpose processor executing software to operate in manner that is capable of performing the task(s) at issue. “Configured to” may also include adapting a manufacturing process, e.g., a semiconductor fabrication facility, to fabricate devices, e.g., integrated circuits that are adapted to implement or perform one or more tasks.

As used in this disclosure, the term ‘machine,’ ‘circuitry’ or ‘logic’ refers to all of the following: (a) hardware-only circuit implementations such as implementations in only analog and/or digital circuitry and (b) combinations of circuits and software and/or firmware, such as (as applicable): (i) to a combination of processor(s) or (ii) to portions of processor(s)/software including digital signal processor(s), software, and memory (ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘machine,’ ‘circuitry’ or ‘logic’ applies to all uses of this term in this application, including in any claims. As a further example, as used in this application, the term ‘machine,’ ‘circuitry’ or ‘logic’ also covers an implementation of merely a processor or multiple processors or portion of a processor and its (or their) accompanying software and/or firmware. The term ‘machine,’ ‘circuitry’ or ‘logic’ also covers, for example, and if applicable to a particular claim element, an integrated circuit for a storage device.

As used herein, the terms ‘first,’ ‘second,’ ‘third,’ and so on are used as labels for nouns that they precede, and do not imply any type of ordering, e.g., spatial, temporal, logical, etc. The terms ‘first’ and ‘second’ do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term ‘based on’ is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

An embodiment of the present invention can provide an apparatus and a method for improving performance of a data processing system including a shared memory device or a memory expander.

An embodiment of the present invention can provide a memory expansion device, a shared memory device, a memory system, a memory expansion device, a controller included in a shared memory device or memory system, a switch device and a fabric manager connecting a host and a memory system, a memory expansion device, or a data processing device including a shared memory device or a memory system.

In an embodiment of the present invention, a data processing system can include a fabric instance configured to perform data communication between at least one host and a plurality of memory devices including a first memory device and a second memory device. The fabric instance can include a buffer. The fabric instance can be configured to: receive write data including first data and second data from the at least one host; store the second data in the buffer; transfer the first data to the first memory device; and transfer the second data stored in the buffer to the second memory device at a preset timing after transferring the first data.

The first memory device can be configured to operate at a faster data input/output speed than the second memory device.

The first memory device can include a plurality of volatile memory cells, and the second memory device can include a plurality of non-volatile memory cells.

The second data can be associated with the first data. The second data can include metadata, error correction code (ECC) data, security data, or active command count information. The buffer can include a plurality of sub-buffers configured to store therein respective types of the secondary data within the second data.

The plurality of sub-buffers can include a first buffer configured to store the metadata; a second buffer configured to store the ECC data; a third buffer configured to store the security data; and a fourth buffer configured to store the active command count information.

The preset timing can include a first timing when the buffer is full of the second data and a second timing when the fabric instance enters an idle state. The fabric instance can include a scheduler configured to transfer a first write request regarding the first data to the first memory device and generate a second write request regarding the second data to be transferred to the second memory device at the preset timing; and hazard control circuitry configured to control, when a read request with a same address with the first write request is input to the fabric instance, the scheduler to keep an order of processing or transmitting the first write request and the read request.

The fabric instance can further include a CXL switch comprising at least one virtual peripheral component interconnect (PCI)-PCI bridge (vPPB) and at least one PCI-PCI bridge (PPB); and a fabric manager configured to control connection between the bridges in the CXL switch.

The fabric manager can be further configured to control, when at least one sub-buffer included in the buffer is full of the second data, the CXL switch to transfer data from the full sub-buffer to the second memory device.

The fabric instance can be further configured to generate, when a read request for the write data is input from the host, a first read request regarding the first data and a second read request regarding the second data, and check whether the second data is stored in the buffer before transferring the first and second read requests to the plurality of memory devices.

The fabric instance can be further configured to transfer, when the second data is not stored in the buffer, the second read request to the second memory device, and transfer the first read request to the first memory device after obtaining the second data from the second memory device in response to the second read request.

In another embodiment, a fabric manager can control a switch connected to plural hosts and plural logical devices. The fabric manager can include a buffer configured to store secondary data associated with data stored in the plural logical devices; a scheduler configured to receive a read request transferred from at least one of the plural hosts, transfer a first read request to a first logical device storing first data included in read data corresponding to the read request, generate a second read request to be transferred to a second logical device based on whether second data included in the read data is stored in the buffer, and determine a timing of transferring the first read request based on the generating of the second read request; and hazard control circuitry configured to control, when a write request with a same address as the read request is input from one of the plural hosts, the scheduler to keep the timing of transferring the first read request.

The first logical device can operate at a faster data input/output speed than the second logical device.

The first logical device can include a plurality of volatile memory cells, and the second logical device can include a plurality of non-volatile memory cells.

The second data can be associated with the first data. The second data can include metadata, error correction code (ECC) data, security data, and active command count information. The buffer can include a plurality of sub-buffers configured to store therein respective types of the secondary data within the second data.

The plurality of sub-buffers can include a first buffer configured to store the metadata; a second buffer configured to store the ECC data; a third buffer configured to store the security data; and a fourth buffer configured to store the active command count information.

The fabric manager can be coupled to a CXL switch comprising at least one virtual PCI-PCI bridge (vPPB) and at least one PCI-PCI bridge (PPB). The fabric manager can be further configured to control connection between the bridges in the CXL switch.

The scheduler can be configured to: generate the second read request, when the second data is not stored in the buffer; and transfer the second read request to the second logical device before transferring the first read request.

In another embodiment, a data processing system can include a plurality of hosts, each host comprising a root port; a plurality of logical devices comprising a plurality of first logical devices storing user data and at least one second logical device storing secondary data associated with the user data; and a fabric manager configured to receive a command for data input/output from the plurality of hosts, generate plural sub commands for first user data and first secondary data in response to the command, and store the first secondary data in a buffer or read the first secondary data from the buffer, according to a sub command for the first secondary data among the plural sub commands.

The plurality of first logical devices can be configured to operate at a faster data input/output speed than the at least one second logical device.

The secondary data can include metadata, error correction code (ECC) data, security data, and active command count information. The buffer can include a first buffer configured to store the metadata; a second buffer configured to store the ECC data; a third buffer configured to store the security data; and a fourth buffer configured to store the active command count information.

Embodiments will now be described with reference to the accompanying drawings, wherein like numbers reference like elements.

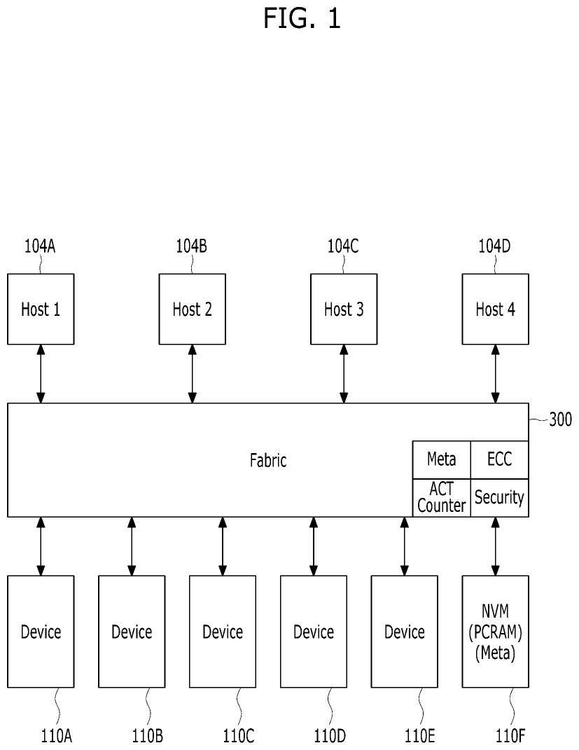

FIG. 1 describes an example of a data processing system according to an embodiment of the present disclosure.

Referring to FIG. 1, a data processing system may include a plurality of hosts 104A, 104B, 104C, 104D and a plurality of logical devices 110A, 110B, 110C, 110D, 110E, 110F. The plurality of hosts 104A, 104B, 104C, 104D and the plurality of logical devices 110A, 110B, 110C, 110D, 110E, 110F may be coupled through a network fabric 300.

The network fabric 300 may include a basic infrastructure of a computer network that is capable of providing communication between network devices. The network fabric 300 can provide an extensible and flexible framework for forming a network by interconnecting plural devices such as a switch, a router, and a server. The network fabric 300 may determine a data transmission method and an overall operation performed within the network.

An example of the network fabric 300 is a switched fabric. In the switched fabric, each device is coupled to one or more centralized switches that transfer data between devices. Another example is a mesh fabric, where each device connects to every other device on a network, allowing multiple paths for data to travel in the network. According to an embodiment, the network fabric 300 may be configured based on a combination of a switched fabric and a mesh fabric.

Configuration and operations of the network fabric 300 may affect performance, scalability, and reliability of the network. According to embodiment, the network fabric 300 may provide high-speed data transmission, efficient use of network resources, robust error handling, and recovery mechanisms. For example, a Compute Express Link (CXL) interface can couple the network fabric 300 to the plurality of hosts 104A, 104B, 104C, 104D and the plurality of logical devices 110A, 110B, 110C, 110D, 110E, 110F.

Types of data stored in the plurality of logical devices 110A, 110B, 110C, 110D, 110E, 110F supporting the CXL interface may increase. For example, the plurality of hosts 104A, 104B, 104C, 104D may access the plurality of logical devices 110A, 110B, 110C, 110D, 110E, 110F through the CXL interface. Therefore, information (e.g., security information, ownership information, etc.) may be required to allow a specific host to access a specific logical device. In addition, because plural data input/output commands output from the plurality of hosts 104A, 104B, 104C, 104D may be transferred and executed through the network fabric 300, a specific information (e.g., information regarding the number of active commands, etc.) might be used for reducing a latency until each operation corresponding to each command may be executed by the plurality of logical devices 110A, 110B, 110C, 110D, 110E, 110F.

In order to support a CXL interface, additional data corresponding to user data may increase in addition to user data transmitted from the plurality of hosts 104A, 104B, 104C, and 104D. Due to the increase in additional data, data storage capability capable of storing user data in the plurality of logical devices 110A, 110B, 110C, 110D, 110E, and 110F may decrease. In order to overcome this, the number of logical devices may be increased. However, as the number of logical devices is increased, the complexity of components included in the network fabric 300 may also increase. In order to address this issue, the plurality of logical devices 110A, 110B, 110C, 110D, 110E, and 110F may be configured as different types of memory devices or memory systems instead of the same type of memory device or memory system.

According to an embodiment, among the plurality of logical devices 110A, 110B, 110C, 110D, 110E, 110F, the first to fifth logical devices 110A, 110B, 110C, 110D, 110E can be configured to have a faster data input/output speed than the sixth logical device 110F. For example, each of the first to fifth logical devices 110A, 110B, 110C, 110D, 110E may include a volatile memory device (e.g., DRAM, etc.) supporting high-speed data input/output operations. The sixth logical device 110F may include a non-volatile memory device (e.g., PCRAM, NVM, etc.) that supports low-speed data input/output operations but has a large storage space.

The network fabric 300 may divide data transmitted from the plurality of hosts 104A, 104B, 104C, 104D into user data and secondary data associated with the user data before performing data input/output operations. For example, user data included in write data transferred from the plurality of hosts 104A, 104B, 104C, 104D can be stored in the first to fifth logical devices 110A, 110B, 110C, 110D, 110E that support high-speed data input/output operations, and secondary data among the write data can be stored in the sixth logical device 110F providing a low-speed data input/output operation but has a large storage space. When one of the plurality of hosts 104A, 104B, 104C, 104D read data, the network fabric 300 can read user data from the first to fifth logical devices 110A, 110B, 110C, 110D, 110E and read secondary data from the sixth logical device 110F. Through this method, it is possible to solve an issue in which data storage capability for user data in the first to fifth logical devices 110A, 110B, 110C, 110D, 110E is reduced due to secondary data.

Further, types of secondary data may be changed in response to the performance or configuration of data communication supported by the network fabric 300. If the user data and the secondary data are stored in a same logical device when types and sizes of the secondary data corresponding to the user data are changed, a size of a storage region in which the user data can be stored in the corresponding logical device may continue to vary. However, as described in FIG. 1, if the secondary data is stored in a separate storage device which is different and distinguishable from the logical devices in which the user data is stored, the size of the storage region for storing the user data might not be changed even if the type and size of the secondary data is changed. This advantage could facilitate effective maintenance of data processing system and data infrastructure including the data processing system.

However, data input/output speeds of the first to fifth logical devices 110A, 110B, 110C, 110D, 110E and the sixth logical device 110F may be different. To this end, the network fabric 300 may include a plurality of buffers (Meta, ECC, ACT Counter, Security). The network fabric 300 can temporarily store the secondary data in the plurality of buffers (Meta, ECC, ACT Counter, Security) or cache the secondary data to overcome a latency caused by a difference in data input/output speed between the first to fifth logical devices 110A, 110B, 110C, 110D, 110E and the sixth logical device 110F.

For example, in a write operation, the network fabric 300 can transfer user data to the first to fifth logical units 110A, 110B, 110C, 110D, 110E. But secondary data corresponding to the user data can be temporarily stored in the plurality of buffers (Meta, ECC, ACT Counter, Security). When each of the plurality of buffers (Meta, ECC, ACT Counter, Security) cannot store any more secondary data, the network fabric 300 may transfer the secondary data stored in any buffer of the plurality of buffers (Meta, ECC, ACT Counter, Security) to the sixth logical device 110F. During a read operation, the network fabric 300 may cache, in the plurality of buffers (Meta, ECC, ACT Counter, Security), at least some of the additional data stored in the sixth logical device 110F. The network fabric 300 reads user data from the first to fifth logical devices 110A, 110B, 110C, 110D, 110E in response to read requests input from the plurality of hosts 104A, 104B, 104C, 104D. Secondary data corresponding to the user data may be read from the plurality of buffers (Meta, ECC, ACT Counter, Security). Then, the network fabric 300 can transmit both the user data and secondary data to the plurality of hosts 104A, 104B, 104C, 104D.

Because types and sizes of the secondary data may vary, the network fabric 300 may allocate different buffers corresponding to the types of the secondary data. In addition, the size of each buffer in the network fabric 300 may be determined based on a preset size of each type of the secondary data. Hereinafter, representative examples of the secondary data will be described.

For example, a first buffer (Meta) among the plurality of buffers (Meta, ECC, ACT Counter, Security) may be allocated to store metadata. The metadata can include data that provides information regarding user data. The metadata can provide additional information such as a date the user data was created, a date it was last modified, a size of the user data, a format of the user data, and other relevant details of the user data. The metadata can be utilized by the network fabric 300 to manage or organize the user data. Further, applications running on the plurality of hosts 104A, 104B, 104C, 104D can use the metadata for determining how to display or process the user data in a specific way. According to embodiment, the metadata may also be used for a security purpose, such as controlling access to the user data or tracking changes to the user data. The metadata could be used to organize and manage a large amount of user data and ensure integrity of the user data.

For example, among a plurality of buffers (Meta, ECC, ACT Counter, Security), the second buffer (ECC) may be configured to store error correction code (ECC) data (ECC data). The ECC data may include data (e.g., a parity) generated by an error correction code. The plurality of hosts 104A, 104B, 104C, 104D can generate ECC data associated with user data to detect and correct an error in the user data stored in the first to fifth logical devices 110A, 110B, 110C, 110D, 110E. A size of the ECC data may vary depending on an error correction code and an error correction algorithm used by each of the plurality of hosts 104A, 104B, 104C, 104D. The ECC data can be used to improve data reliability and reduce a risk of data corruption or data loss. For example, the ECC data could be used in an application where data integrity is important, such as a storage device included in a data center including the first to fifth logical devices 110A, 110B, 110C, 110D, 110E or a system having high availability.

For example, a third buffer (Security) among the plurality of buffers (Meta, ECC, ACT Counter, Security) may be configured to store security data. The security data may include types of data protected by various security measures such as encryption and access control, to prevent unauthorized access, use, disclosure, disruption, modification, or destruction of user data. The security data can be stored in a secure manner, such as an encrypted storage device or a secure storage area within a cloud storage system, to ensure data confidentiality and allow only authorized individuals to use or access data. This type of data protected by the security data can include sensitive information such as financial records, personally identifiable information or confidential business information.

For example, a fourth buffer (ACT Counter) among the plurality of buffers (Meta, ECC, ACT Counter, Security) may be configured to store active command count information. The active command count information can indicate the number of active commands that have been processed concurrently by a given logical device. In particular, the active command count information may be used in relation to a non-volatile memory (NVM) device such as a flash memory or a solid state drive (SSD). The active command count information can be limited by parallelism of a controller and a memory architecture in a non-volatile memory system, as well as other factors such as power consumption and performance constraints. The active command count information could be used to ensure efficient and effective use of the plurality of logical devices 110A, 110B, 110C, 110D, 110E, 110F including the non-volatile memory system and to optimize overall performance of a data processing system including the non-volatile memory system.

FIG. 1 shows four different secondary data and four buffers that could separately store each type of the secondary data. However, the types of secondary data can be changed according to the performance and configuration of the data processing system. According to an embodiment, the number of buffers could also be changed based on types of the secondary data.

Hereinafter, a data processing system for storing user data and secondary data corresponding to the user data in the plurality of logical devices, including different types of memory devices coupled through the network fabric 300 supporting the CXL interface, will be described in detail.

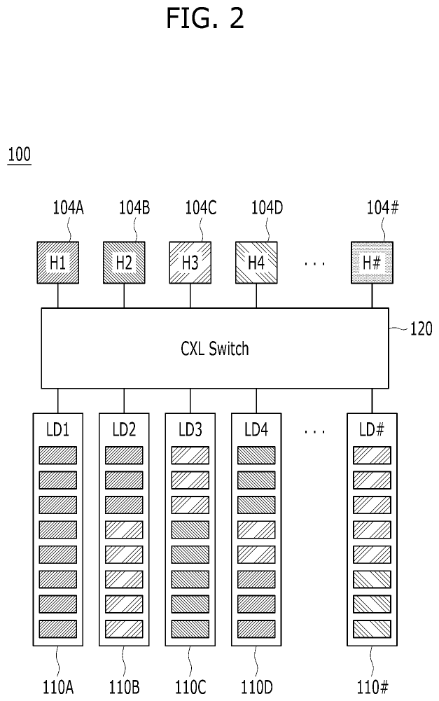

FIG. 2 describes an operation of a data processing system according to an embodiment of the present disclosure. Specifically, FIG. 2 describes a CXL switch and a CXL interface.

In FIG. 2, a data processing apparatus 100 is shown as a first example of a data infrastructure. The data processing apparatus 100 can include a plurality of hosts 104A, 104B, 104C, 104D, . . . , 104 # and a plurality of logical devices 110A, 110B, 110C, 110D, . . . , 110 #. The plurality of hosts 104A, 104B, 104C, 104D, . . . , 104 # and the plurality of logical devices 110A, 110B, 110C, 110D, . . . , 110 # may be connected by a CXL switch 120.

Data infrastructure may refer to a digital infrastructure that promotes data sharing and consumption. Like other infrastructures, the data infrastructure can include structures, services, and facilities that are necessary for data sharing and consumption. For example, the data infrastructure includes a variety of components, including hardware, software, networking, services, policies, etc. that enable data consumption, storage, and sharing. The data infrastructure can provide a foundation for creating, managing, using, and protecting data.

For example, data infrastructure can be divided into physical infrastructure, information infrastructure, business infrastructure, and the like. The physical infrastructure may include a data storage device, a data processing device, an input/output network, a data sensor facility, and the like. The information infrastructure may include data repositories such as business applications, databases, and data warehouses, virtualization systems, and cloud resources and services including virtual services, and the like. The business infrastructure may include business intelligence (BI) systems and analytics tools systems such as big data, artificial intelligence (AI), machine learning (ML), and the like.

A plurality of hosts (e.g., 104A, 104B) may be understood as a computing device such as personal computers and workstations. For example, a first host (Host1, 104A) may include a host processor, a host memory, and a storage device. The host processor may perform data processing operations in response to the user's needs, temporarily store data used or generated in the process of performing the data processing operations in the host memory as an internal volatile memory, or permanently store the data in the storage device as needed.

When a user performs tasks that require many high speed operations, such as calculations or operations related to artificial intelligence (AI), machine learning (ML), and big data, resources such as a host memory and a storage device included in a host (e.g., the first host 104A) might be not sufficient. The plurality of logical devices 110A, 110B, 110C, 110D, . . . , 110 # as a shared memory device coupled to the host may be used to overcome a limitation of internal resources such as the host memory and the storage device.

Referring to FIG. 2, the CXL switch 120 can couple the plurality of hosts 104A, 104B, 104C, 104D, . . . , 104 # and the plurality of logical devices 110A, 110B, 110C, 110D, . . . , 110 # to each other. According to an embodiment, some of host processors could constitute a single system. In another embodiment, each host processor could be included in a distinct and different system. Further, according to an embodiment, some logical devices could constitute a single shared memory device. In another embodiment, each logical device could be included in a distinct and different shared memory device.

A data storage area included in the plurality of logical devices 110A, 110B, 110C, 110D, . . . , 110 # can be exclusively assigned or allocated to the plurality of hosts 104A, 104B, 104C, 104D, . . . , 104 #. For example, the entire storage space of the storage LD1 of first logical device 110A may be exclusively allocated to and used by the first host 104A. That is, another host processor might not access the storage LD1 in first logical device 110A while the storage LD1 is allocated to the first host 104A. A partial storage space in the storage LD2 of second logical device 110B may be allocated to the first host 104A, while another portion therein may be allocated to the third host 104C. In addition, a partial storage space in the storage LD2 of second logical device 110B might not be used by another host processor except for the storage LD2 of second logical device. The storage LD3 of third logical device 110C may be allocated to, and used by, the second host 104B and the third host 104C. The storage LD4 of fourth logical device 110D may be allocated to, and used by, the first host 104A, the second host 104B, and the third host 104C.

In the plurality of logical devices 110A, 110B, 110C, 110D, . . . , 110 #, unallocated storage spaces can be further allocated to the plurality of hosts 104A, 104B, 104C, 104D, . . . , 104 # based on a request of the plurality of hosts 104A, 104B, 104C, 104D, . . . , 104 #. Further, the plurality of hosts 104A, 104B, 104C, 104D, . . . , 104 # can request deallocation or release of the previously allocated storage space. In response to the request of the plurality of hosts 104A, 104B, 104C, 104D, . . . , 104 #, the CXL switch 120 may control connection or data communication between the plurality of hosts 104A, 104B, 104C, 104D, . . . , 104 # and the plurality of logical devices 110A, 110B, 110C, 110D, . . . , 110 #.

Referring to FIG. 2, the plurality of hosts 104A, 104B, 104C, 104D, . . . , 104 # may include the same component, but their internal components may be changed according to an embodiment. In addition, the plurality of logical devices 110A, 110B, 110C, 110D, . . . , 110 # may include the same component, but their internal components may be changed according to an embodiment.

According to an embodiment, the CXL switch 120 can be configured to utilize the plurality of logical devices 110A, 110B, 110C, 110D, . . . , 110 # to provide versatility and scalability of resources, so that the plurality of hosts 104A, 104B, 104C, 104D, . . . , 104 # can overcome limitations of internal resources. Herein, CXL is a type of interface which utilizes different types of devices more efficiently in a high-performance computing system such as artificial intelligence (AI), machine learning (ML), and big data. For example, when the plurality of logical devices 110A, 110B, 110C, 110D, . . . , 110 # includes a CXL-based DRAM device, the plurality of hosts 104A, 104B, 104C, 104D, . . . , 104 # may expand memory capacity available for storing data.

If the CXL switch 120 provides cache consistency, there may be delays in allowing other processors to use variables or data updated by a specific processor in a process of sharing the variables or the data stored in a specific memory area. To reduce the delay in using the plurality of logical devices 110A, 110B, 110C, 110D, . . . , 110 #, a CXL protocol or interface through the CXL switch 120 can assign a logical address range to memory areas in the plurality of logical devices 110A, 110B, 110C, 110D, . . . , 110 #. The logical address range is used by the plurality of hosts 104A, 104B, 104C, 104D, . . . , 104 #. Using a logical address in the logical address range, the plurality of hosts 104A, 104B, 104C, 104D, . . . , 104 # can access the memory areas allocated to the plurality of hosts 104A, 104B, 104C, 104D, . . . , 104 #. When each of the plurality of hosts 104A, 104B, 104C, 104D, . . . , 104 # requests a storage space for a specific logical address range, an available memory area included in the plurality of logical devices 110A, 110B, 110C, 110D, . . . , 110 # can be allocated for the specific logical address range. When each of the plurality of hosts 104A, 104B, 104C, 104D, . . . , 104 # requests a memory area based on different logical addresses or different logical address ranges, memory areas in the plurality of logical devices 110A, 110B, 110C, 110D, . . . , 110 # can be allocated for the different logical addresses or the different logical address ranges. If the plurality of hosts 104A, 104B, 104C, 104D, . . . , 104 # do not use a same logical address range, however, then a variable or data assigned to a specific logical address might not be shared by the plurality of hosts 104A, 104B, 104C, 104D, . . . , 104 #. Each of the plurality of hosts 104A, 104B, 104C, 104D, . . . , 104 # can use the plurality of logical devices 110A, 110B, 110C, 110D, . . . , 110 # as a memory expander to overcome limitations of their internal resources.

According to an embodiment, the plurality of logical devices 110A, 110B, 110C, 110D, . . . , 110 # may include a controller and a plurality of memories. The controller could be connected to the CXL switch 120 and control the plurality of memories. The controller can perform data communication with the CXL switch (120) through a CXL interface. Further, the controller can perform data communication through a protocol and an interface supported by the plurality of memories. According to an embodiment, the controller may distribute data input/output operations transmitted to a shared memory device and manage power supplied to the plurality of memories in the shared memory device. Depending on an embodiment, the plurality of memories may include a dual in-line memory module (DIMM), a memory add-in card (AIC), and a non-volatile memory device supporting various connections (e.g., EDSFF 1U Long (E1 L.), EDSFF 1U Short (E1 S.), EDSFF 3U Long (E3U Long), EDSF (E3U Short), etc.).

The memory areas included in the plurality of logical devices 110A, 110B, 110C, 110D, . . . , 110 # may be allocated for, or assigned to, the plurality of hosts 104A, 104B, 104C, 104D, . . . , 104 #. A size of memory area allocated for, or assigned to, the plurality of hosts 104A, 104B, 104C, 104D, . . . , 104 # can be changed or modified in response to a request from the plurality of hosts 104A, 104B, 104C, 104D, . . . , 104 #. In FIG. 1, it is shown that the plurality of hosts 104A, 104B, 104C, 104D, . . . , 104 # are coupled to the plurality of logical devices 110A, 110B, 110C, 110D, . . . , 110 # through the CXL switch 120. However, according to an embodiment, the memory areas included in the plurality of logical devices 110A, 110B, 110C, 110D, . . . , 110 # may also be allocated for, or assigned to, a virtual machine (VM) or a container. Herein, a container is a type of lightweight package that includes application codes and dependencies such as programming language runtimes and libraries of a specific version required to run software services. The container could virtualize the operation system. The container can run anywhere from a private data center to a public cloud or even on a developer's personal laptop.

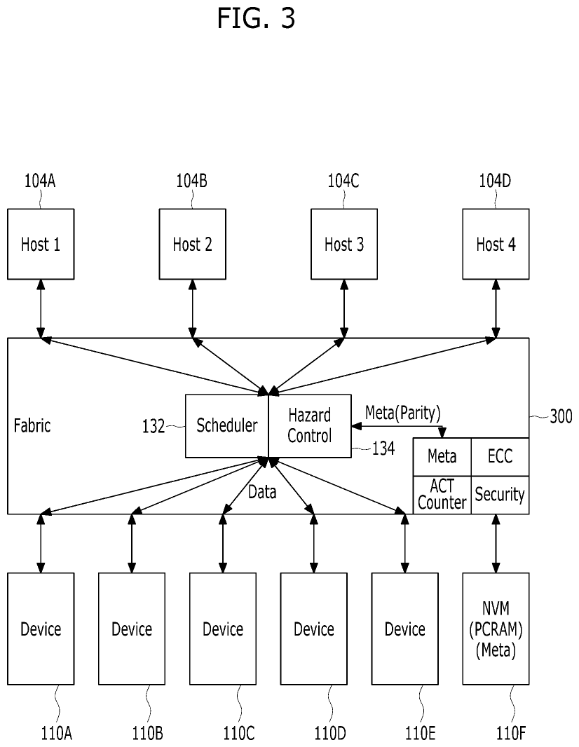

FIG. 3 describes configuration of network fabric in a data processing system according to an embodiment of the present disclosure.

Referring to FIG. 3, the network fabric (Fabric, 300) may be connected to the plurality of hosts 104A, 104B, 104C, 104D and the plurality of logical devices 110A, 110B, 110C, 110D, 110E, 110F.

The CXL interface described in FIGS. 1 to 3 may use metadata for high-speed, low-latency communication between a host processor and an accelerator or memory device. In CXL, a level of detail or precision of information contained in metadata, which is a set of data that provides information about other data, can be described as metadata granularity. The metadata granularity in the CXL can affect system performance, as more detailed metadata can result in higher overhead in terms of consumptions of processing time and bandwidth. On the other hand, less detailed (more granular) metadata may result in lower efficiency in the use of accelerators or memories included in the network fabric 300. An optimal metadata granularity in a C×L system will depend on specific usages and requirements of the system and can be adjusted as needed to achieve a desired balance between performance and efficiency.

As described in FIG. 1, because the granularity of secondary data including metadata might be different for each type of user data or metadata, the network fabric 300 can set up, allocate, or provide different buffers (Meta, ECC, ACT Counter, Security) or caches, based on the type of the secondary data. For example, a preset ECC data corresponding to user data may have a size of 16 bytes, whereas CXL metadata may have a size of 2 bytes. The network fabric 300 may set the plurality of buffers (Meta, ECC, ACT Counter, Security) or caches, and provide a different buffer or cache for each type of secondary data. To cache secondary data in the plurality of buffers (Meta, ECC, ACT Counter, Security), the network fabric 300 can load frequently accessed secondary data from the sixth logic device 110F, which is a low-speed memory device, to the plurality of buffers (Meta, ECC, ACT Counter, Security) which is a high-speed memory device. When temporarily storing secondary data in the plurality of buffers (Meta, ECC, ACT Counter, Security), the network fabric 300 can access or read the corresponding secondary data more quickly in the future. If the network fabric (Fabric, 300) caches secondary data in a plurality of buffers (Meta, ECC, ACT Counter, Security), a time or a process spent to handle the secondary data could be reduced, improving performance of the data processing system.

The plurality of hosts 104A, 104B, 104C, 104D can request an operation such as data input/output operations for writing data to the plurality of logical devices 110A, 110B, 110C, 110D, 110E, 110F or reading data stored in the plurality of logical devices 110A, 110B, 110C, 110D, 110E, 110F. During the operation, the network fabric 300 might not find secondary data associated with user data in the plurality of buffers (Meta, ECC, ACT Counter, Security) (e.g., Cache miss). In this case, latency might be long in the data processing system. To solve this issue, the network fabric (Fabric, 300) may include circuitry, a logic, or a processor which is capable of scheduling commands or requests transmitted from the plurality of hosts 104A, 104B, 104C, 104D and performing hazard control in the scheduling.

Referring to FIG. 3, the network fabric 300 may include a scheduler 132 and a hazard control circuitry 134. The scheduler 132 can determine an order or a schedule of delivering commands or requests transmitted from the plurality of hosts 104A, 104B, 104C, 104D into the plurality of logical devices 110A, 110B, 110C, 110D, 110E, 110F. In addition, because user data and secondary data corresponding to the user data in the plurality of logical devices 110A, 110B, 110C, 110D, 110E, 110F may be stored in different logical devices, the scheduler 132 can generate a first command or a first request for user data (Data) and a second command or a second request for secondary data (Meta (Parity)) corresponding to the user data (Data), in response to a command or a request input from the plurality of hosts 104A, 104B, 104C, 104D. According to an embodiment, the scheduler 132 may determine whether to generate the second command or the second request based on whether the secondary data exists (i.e., is stored or cached) in the plurality of buffers (Meta, ECC, ACT Counter, Security).

In response to the second command or the second request for secondary data generated by the scheduler 132, the hazard control circuitry 134 is configured to control a hazard which could be issued during an operation of storing, or searching for, the secondary data in the plurality of buffers (Meta, ECC, ACT Counter, Security). For example, The hazard control circuitry 134 may control, change, manipulate, or stop a sequence or an order of operations including caching, in the plurality of buffers (Meta, ECC, ACT Counter, Security), the secondary data obtained from the sixth logical device 110F having a slow data input/output speed and transferring the secondary data from a selected buffer of the plurality of buffers (Meta, ECC, ACT Counter, Security) to the sixth logical device 110F to store, in the sixth logical device 110F, the secondary data stored in the selected buffer when the selected buffer becomes full of the secondary data.

For example, a write request with write data may be delivered to the network fabric 300 from at least one of the plurality of hosts 104A, 104B, 104C, 104D. The write data may include user data and secondary data corresponding to the user data. The scheduler 132 may generate a first write request for storing the user data and a second write request for storing the secondary data in response to the write request input along with the write data. The first write request for storing the user data may be transferred to at least one of the first to fifth logical devices 110A, 110B, 110C, 110D, 110E. In addition, the scheduler 132 transfers the secondary data from the plurality of buffers (Meta, ECC, ACT Counter, Security) to the sixth logical device 110F at a preset timing. For example, the preset timing may include a first timing when the buffer is full of the secondary data and a second timing when the network fabric 300 enters an idle state.

According to an embodiment, the data processing system may distribute and store the user data in a plurality of logical devices. The scheduler 132 may transfer the first write request to the plurality of logical devices and transfer the user data to the plurality of logical devices to be distributed and stored in parallel. Further, the scheduler 132 may avoid latencies from occurring in a process of performing an operation corresponding to the write request transmitted from the at least one of the plurality of hosts 104A, 104B, 104C, 104D due to the second write request with the secondary data. For example, the secondary data included in the write data may be classified by types and stored in the plurality of buffers (Meta, ECC, ACT Counter, Security). The scheduler 132 can transfer the secondary data stored in a plurality of buffers (Meta, ECC, ACT Counter, Security) to the sixth logical device 110F at the preset timing after plural input/output operations of storing or reading the user data in or from the first to fifth logical devices 110A, 110B, 110C, 110D, 110E, to avoid or reduce a delay. Through this procedure, even if the data input/output speed of the sixth logical device 110F is slower than that of the first to fifth logical devices 110A, 110B, 110C, 110D, 110E, the network fabric 300 can utilize the plurality of buffers (Meta, ECC, ACT Counter, Security) for temporarily storing the secondary data Meta (Parity). Because data input/output operations of the sixth logical device 110F can be efficiently reconstructed or rescheduled, it is possible to suppress latencies from occurring in the data processing system.

A read request may be forwarded to the network fabric 300 from at least one of the plurality of hosts 104A, 104B, 104C, 104D. The network fabric 300 can recognize that user data and secondary data included in read data associated with the read request are stored in different logical devices. The scheduler 132 in the network fabric 300 may generate a first read request for reading the user data and a second read request for reading the secondary data in response to the read request. The first read request for reading the user data may be transmitted to at least one of the first to fifth logical devices 110A, 110B, 110C, 110D, 110E. In response to the second read request of the scheduler 132, the network fabric 300 can check whether the secondary data is cached in the plurality of buffers (Meta, ECC, ACT Counter, Security) before the first and second read requests are transmitted to the plurality of logical devices 110A, 110B, 110C, 110D, 110E, 110F. When the secondary data is cached in the plurality of buffers (Meta, ECC, ACT Counter, Security) (i.e., Cache Hit), the sixth logical device 110F having a slower data input/output speed than other logical devices might not affect the occurrence of latencies in the data processing system. That is, latencies might not occur by the sixth logical device 110F having a slower data input/output speed than other logical devices.

On the other hand, when the secondary data is not cached in the plurality of buffers (Meta, ECC, ACT Counter, Security) (i.e., Cache Miss), the hazard control circuitry 134 can change an order or a sequence of requests that the scheduler 132 transfers to the plurality of logical devices 110A, 110B, 110C, 110D, 110E, 110F. For example, if the scheduler 132 cannot find the secondary data in the plurality of buffers (Meta, ECC, ACT Counter, Security) in response to the second read request, the hazard control circuitry 134 can control the scheduler 132 to delay the transfer of at least one first read request for reading the user data corresponding to the secondary data which is not cached in the plurality of buffers (Meta, ECC, ACT Counter, Security). While the transfer of the first read request to at least one of the first to fifth logic devices 110A, 110B, 110C, 110D, 110E is delayed, the network fabric 300 can read the secondary data from the sixth logical device 110F and cache the read secondary data into the plurality of buffers (Meta, ECC, ACT Counter, Security). After the secondary data is cached, the scheduler 132 can send the first read request to at least one of the first to fifth logic devices 110A, 110B, 110C, 110D, 110E for reading the user data corresponding to the cached secondary data.

According to an embodiment, the scheduler 132 may change an order of processing or transmitting the first and second read requests by delaying the first read request when corresponding secondary data is not cached in a plurality of buffers (Meta, ECC, ACT Counter, Security). In addition, when secondary data cannot be stored in a plurality of buffers (Meta, ECC, ACT Counter, Security), the scheduler 132 may change the order of processing read and write requests regarding the secondary data by delaying the processing of the write request.

The hazard control circuitry 134 can check whether an issue may occur in a process of changing the order of data input/output operations in the scheduler 132 and control the scheduler 132 to stop changing the order of data input/output operations or restore the original order of data input/output operations when the issue such as a malfunction is expected. For example, a write request and a read request from the first host 104A with the same address may be sequentially transmitted to the network fabric 300. In this case, write data corresponding to the write request transmitted prior to the read request should be stored in at least one of the first to fifth logical devices 110A, 110B, 110C, 110D, 110E. In response to the read request transmitted after the write request, the data, which is stored in the at least one of the first to fifth logical devices 110A, 110B, 110C, 110D, 110E in response to the write request, should be transferred to the first host 104A. If the scheduler 132 changes an order of processing or transmitting a write request and a read request for reasons such as data input/output performance, latencies, etc. when the first host 104A sequentially transfers the write request and the read request, wrong data might be delivered to the first host 104A. Similarly, a read request and a write request from the first host 104A for a same address may be sequentially transmitted to the network fabric 300. Even in this case, if the scheduler 132 changes an order of processing or transmitting the read request and the write request, data, which is received by the first host 104A in response to the read request, may be erroneous. Accordingly, when a read request and a write request for the same address or a write request and a read request are sequentially input, the hazard control circuitry 134 can control the scheduler 132 to keep an order of processing or transmitting the read request and the write request or the write request and the read request for the same address. To avoid a hazard, the hazard control circuitry 134 can include logic or circuitry configured to compare first and second addresses with each other, the first address being associated with a request to be forwarded to at least one of the plurality of first to fifth logical devices 110A, 110B, 110C, 110D, 110E and the second address being associated with a request or a data I/O operation which has been delayed by the scheduler 132.

According to an embodiment, the hazard control circuitry 134 may reduce or prevent a control hazard. The control hazard can occur in computer architectures when the execution of an instruction is delayed due to the need for additional information such as a branch direction or a target address. As a result, if the pipeline of the network is stopped, performance of the processor might be degraded. There are two main types of control risks: a branch hazard and a data hazard. The branch risk may occur when a branch instruction is executed, and the network's pipeline should wait until the branch target address is computed. The data risk may occur when an instruction depends on the result of a previous instruction, and the network's pipeline should wait for data to be computed and written to a register or a specific memory location. To mitigate these risks, the hazard control circuitry 134 may use techniques such as branch prediction and data forwarding.

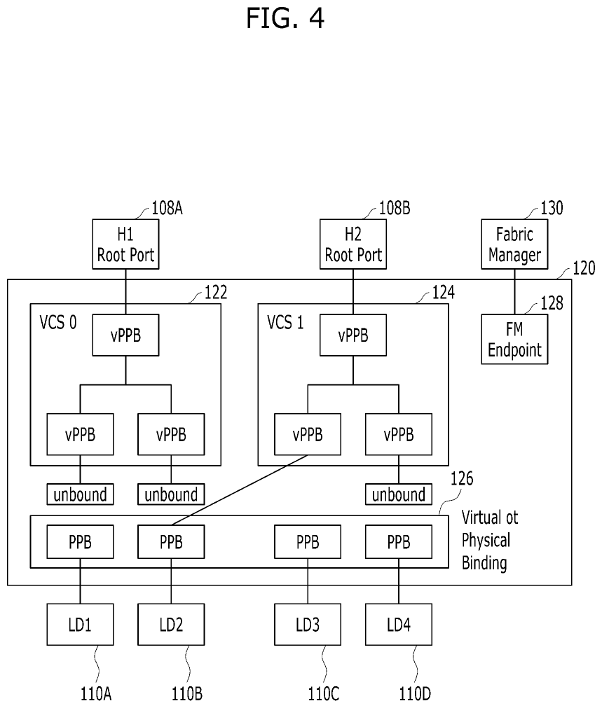

FIG. 4 describes an example of a CXL switch according to an embodiment of the present disclosure.

Referring to FIG. 4, a plurality of root ports 108A, 108B and a plurality of logical devices 110A, 110B, 110C, 110D may be coupled through a CXL switch 120.

According to an embodiment, the plurality of root ports 108A, 108B may be included in a root complex located between the plurality of logical devices 110A, 110B, 110C, 110D, 110E, 110F supporting a CXL interface and the plurality of hosts 104A, 104B, 104C, 104D shown in FIG. 1. The root complex is an interface located between the plurality of hosts 104A, 104B and a connection component such as a PCIe Bus. The root complex may include several components, several chips, system software, and the like, such as a processor interface, a DRAM interface, and the like. The root complex can logically combine hierarchical domains such as PCIe into a single hierarchy. Each fabric instance may include a plurality of logical devices, switches, bridges, and the like.

A fabric instance can logically describe the network fabric 300, which is a group of interconnected nodes that work together to provide a network service. The fabric instance can be established or managed by a controller in the network fabric 300. The fabric instance can be used to automate and manage a network service such as network resource provisioning, network device configuration, and network performance monitoring. For example, in a data center including a data processing system, the fabric instance can be used to manage physical and logical components of the network including switches, routers, and other network devices, as well as virtual network components such as virtual switches and virtual routers. The fabric instance can provide a single point of management for the network and allow a network administrator to centrally manage the network and automate network tasks. Further, the fabric instance can be commonly used in software-defined networking (SDN) and network functions virtualization (NFV). The fabric instance can support or provide a flexible and scalable network infrastructure that can be easily managed and configured to meet changing network requirements.

The root complex can calculate a size of a storage space in each logical device and map the storage space to an operating system, to generate an address range table. According to an embodiment, the plurality of hosts 104A, 104B may be connected to different root ports 108A, 108B respectively to configure different host systems.

The root ports 108A, 108B may refer to a PCIe port included in the root complex that forms a part of PCIe interconnection hierarchy through a virtual PCI-PCI bridge which is coupled to the root ports 108A, 108B. Each of the root ports 108A, 108B may have a separate hierarchical area. Each hierarchical area may include one endpoint, or sub-hierarchies including one or more switches or a plurality of endpoints. Herein, an endpoint may refer to one end of the communication channel. The endpoint may be determined according to circumstances. For example, in a case of physical data communication, an endpoint may refer to a server or a terminal, which is the last device connected through a data path. In terms of services, an endpoint may indicate an Internet identifier (e.g., uniform resource identifiers, URIs) corresponding to one end of the communication channel used when using a service. An endpoint may also be an Internet identifier (URIs) that enables an Application Programming Interface (API), which is a set of protocols that allow two systems (e.g., applications) to interact or communicate with each other, to access resources on a server.

The CXL switch 120 is a device that can attach the plurality of logical devices 110A, 110B, 110C, 110D, which are multiple devices, to one root port 108A or 108B. The CXL switch 120 can operate like a packet router and recognize which path a packet should go through based on routing information different from an address of the packet. Referring to FIG. 2, the CXL switch 120 may include a plurality of bridges.

Here, CXL is a dynamic multi-protocol technology designed to support accelerators and memory devices. CXL can provide a set of protocols including protocols (e.g., CXL.io) that include PCIe-like I/O semantics, protocols (e.g., CXL.cache) that include caching protocol semantics, and protocols including memory access semantics over individual or on-package (on-package) links. Semantics may refer to prediction and ascertainment of what will happen and what the outcome will be to the meaning given by units such as expressions, sentences, and program codes when a program or an application, which is configured of a language which is a type of communication system governed by sentence generation rules in which elements are combined in various ways. For example, a first CXL protocol (CXL.io) can be used for search and enumeration, error reporting, and Host Physical Address (HPA) inquiry. A second CXL protocol (CXL.mem) and a third CXL protocol (CXL.cache) may be selectively implemented and used by a specific accelerator or a memory device usage model. The CXL interface can provide low-latency, high-bandwidth paths for an accelerator to access a system or for a system to access a memory connected to a CXL device.

The CXL switch 120 is an interconnect device for connecting the plurality of root ports 108A, 108B and the plurality of logical devices 110A, 110B, 110C, 110D supporting CXL-based data communication. For example, the plurality of logical devices 110A, 110B, 110C, 110D may refer to a PCIe-based device or a logical device LD. Here, PCIe (i.e., Peripheral Component Interconnect Express) refers to a protocol or an interface for connecting a computing device and a peripheral device. Using a slot or a specific cable to connect a host such as a computing device to a memory system such as a peripheral device connected to the computing device, PCIe can have a bandwidth over several hundreds of MBs per second (e.g., 250 MB/s, 500 MB/s, 984.6250 MB/s, 1969 MB/s, etc.) by using a plurality of pins (e.g., 18, 32, 49, 82, etc.) and at least one wire (e.g., x1, x4, x8, x16). Using CXL switching and pooling, the plurality of host processors and the plurality of logical devices can be connected through the CXL switch 120, and all or a part of each logical device connected to the CXL switch 120 can be assigned as a logical device to several host processors. A logical device LD is an entity that refers to a CXL endpoint bound to a virtual CXL switch (VCS).

According to an embodiment, the logical device LD may include a single logical device (Single LD) or a multi-logical device (MLD). The plurality of logical devices 110A, 110B, 110C, 110D that support the CXL interface could be partitioned into up to 16 distinguished logical devices like a memory managed by the host. Each logical device can be identified by a logical device identifier LD-ID used in the first CXL protocol (CXL.io) and the second CXL protocol (CXL.mem). Each logical device can be identified in the virtual hierarchy (VH). A control logic or circuit included in each of the plurality of logical devices 110A, 110B, 110C, 110D may control and manage a common transaction and link layer for each protocol. For example, the control logic or circuit in the plurality of logical devices 110A, 110B, 110C, 110D can access various architectural functions, control, and status registers through an Application Programming Interface (API) provided by a fabric manager 130, so that the logical device LD can be configured statically or dynamically.

Referring to FIG. 4, the CXL switch 120 may include a plurality of virtual CXL switches 122, 124. The virtual CXL switch (VCS) 122, 124 may include entities within a physical switch belonging to a single virtual hierarchy (VH). Each entity may be identified using a virtual CXL switch identifier VCS-ID. The virtual hierarchy (VH) may include a rendezvous point (RP), a PCI-to-PCI bridge (PPB) 126, and an endpoint. The virtual hierarchy (VH) may include everything arranged under the rendezvous point (RP). The structure of the CXL virtual layer may be similar to that of PCIe. A port connected to a virtual PCI-PCI bridge (vPPB) and a PCI-PCI bridge (PPB) inside a CXL switch 120 controlled by the fabric manager (FM) 130 can provide or block connectivity in response to various protocols (PCIe, CXL 1.1, CXL 2.0 SLD, or CXL 2.0 MLD). Here, the fabric manager (FM) 130 can control an aspect of the system related to binding and management of pooled ports and devices. The fabric manager (FM) 130 can be considered a separate entity distinguished from a switch or host firmware. In addition, virtual PCI-PCI bridges (vPPBs) and PCI-PCI bridges (PPBs) controlled by the fabric managers (FM) 130 can provide data links including traffic from multiple virtual CXL switches (VCS) or unbound physical ports. Messages or signals by the fabric manager (FM) 130 can be delivered to a fabric manager endpoint 128 in the CXL switch 120, and the CXL switch 120 can control multiple switches or bridges included therein based on the message or signal delivered to the fabric manager endpoint 128.

According to an embodiment, the CXL switch 120 may include a PCI-PCI bridge PPB 126 corresponding to each of the plurality of logical devices 110A, 110B, 110C, 110D. The plurality of logical devices 110A, 110B, 110C, 110D may have a 1:1 correspondence relationship with the PCI-PCI bridge PPB 126. In addition, the CXL switch 120 may include a virtual PCI-PCI bridge (vPPB) corresponding to each of the plurality of root ports 108A, 108B. The plurality of root ports 108A, 108B and the plurality of virtual PCI-PCI bridges vPPB 122, 124 may have a 1:1 correspondence relationship. The CXL switch 120 may have a different configuration corresponding to the number of the plurality of root ports 108A, 108B and the number of the plurality of logical devices 110A, 110B, 110C, 110D.

Referring to FIG. 4, the fabric manager (FM) 130 may connect one virtual PCI-PCI bridge (vPPB) among the second virtual CXL switches 122 with one PCI-PCI bridge (PPB) among PCI-PCI bridges (PPBs) 126 and unbind other virtual PCI-PCI bridges (vPPB) included in the first CXL switches 122 and the second virtual CXL switches 124 to any PCI-PCI bridge (PPB) among PCI-PCI bridges (PPBs) 126. That is, connectivity between the first CXL switches 122, or the second virtual CXL switches 124, and the PCI-PCI bridges (PPBs) 126 may be achieved selectively. Like this configuration, the CXL switch 120 can perform a function of connecting a virtual layer to a physical layer (Virtual to Physical Binding).

Referring to FIGS. 2 and 4, the storage space (e.g., memory areas) in the plurality of logical devices 110A, 110B, 110C, 110D, . . . , 110 # may be shared by the plurality of hosts 104A, 104B, 104C, 104D, . . . , 104 #. For example, the storage space of the first logical device storage LD1 may be configured to store data corresponding to a logical address range of 1 to 100, and the storage space of the second logical device storage LD2 may be configured to store data corresponding to another logical address range of 101 to 200. The plurality of logical devices 110A, 110B, 110C, 110D can be accessed through logical addresses of 1 to 400. Further, the plurality of hosts 104A, 104B, 104C, 104D, . . . , 104 # can share access information regarding which host processor uses or accesses the storage space in the plurality of logical devices 110A, 110B, 110C, 110D based on the logical addresses of 1 to 400. For example, logical addresses of 1 to 50 may be assigned to, and allocated for, the first host 104A, and other logical addresses of 51 to 100 may be assigned to, and allocated for, the second host 104B. In addition, other logical addresses of 101 to 200 may be assigned to, and allocated for, the first host 104A.

A range of logical addresses assigned to each logical device may be different in response to a size of the storage space of the logical device included in the shared memory device. In addition, a storage space that has been allocated to the plurality of hosts 104A, 104B, 104C, 104D, . . . , 104 # may be released in response to a release request of the plurality of hosts 104A, 104B, 104C, 104D, . . . , 104 #.

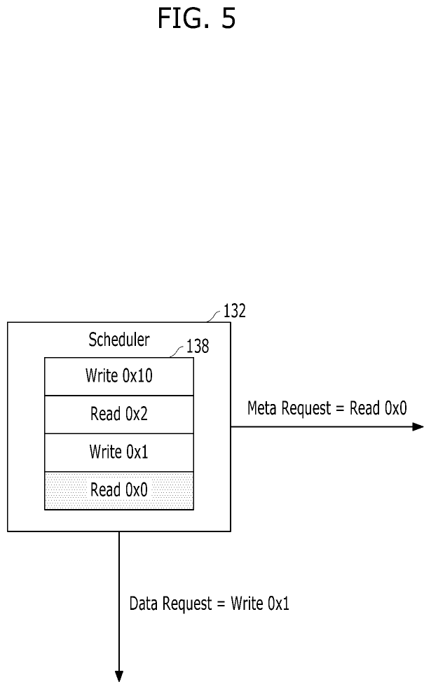

FIG. 5 describes a scheduler according to an embodiment of the present disclosure.

Referring to FIG. 5, the scheduler 132 may receive a plurality of data input/output requests and output a first request (Data Request) for user data and a second request (Meta Request) for secondary data associated with the user data. The scheduler 132 may include a plurality of queues 138 or a plurality of caches or buffers. For example, the scheduler 132 may sequentially store a plurality of data input/output requests (Read 0x0, Write 0x1, Read 0x2, Write 0x10) transmitted from at least one of the plurality of hosts 104A, 104B, 104C, 104D in the queue 138. The scheduler 132 can generate a first request (Data Request) and a second request (Meta Request) corresponding to each data input/output request input from the at least one of the plurality of hosts 104A, 104B, 104C, 104D.

For a read request (Read 0x0) transmitted from at least one of the plurality of hosts 104A, 104B, 104C, 104D, the scheduler 132 can output a second read request (Meta Request=Read 0x0) corresponding to the read request (Read 0x0). That is, the second read request (Meta Request=Read 0x0) for secondary data is generated in response to the read request (Read 0x0). As described with reference to FIG. 3, the scheduler 132 may generate the second read request for the secondary data based on whether the secondary data exists in the plurality of buffers (Meta, ECC, ACT Counter, Security). The scheduler 132 might not need to generate the second read request when the secondary data is cached and found in the plurality of buffers (Meta, ECC, ACT Counter, Security). If the secondary data corresponding to the read request (Read 0x0) is not cached nor found in the plurality of buffers (Meta, ECC, ACT Counter, Security), the scheduler 132 can delay transmission of a first read request for reading user data, which is associated with the secondary data not cached in the plurality of buffers (Meta, ECC, ACT Counter, Security), to the first through fifth logical devices 110A, 110B, 110C, 110D, 110E. In FIG. 5, the scheduler 132 can output, earlier than a first read request corresponding to the read request (Read 0x0), a first write request (Data Request=Write 0x1) generated in response to a write request (Write 0x1) which is input following the read request (Read 0x0). That is, if the write request (Write 0x1) is input later than the read request (Read 0x0), it is described that the second read request (Meta Request=Read 0x0) can be output for the secondary data not cached but the first write request (Data Request=Write 0x1) for user data corresponding to the write request (Write 0x1) can be output earlier than the first read request corresponding to the read request (Read 0x0).

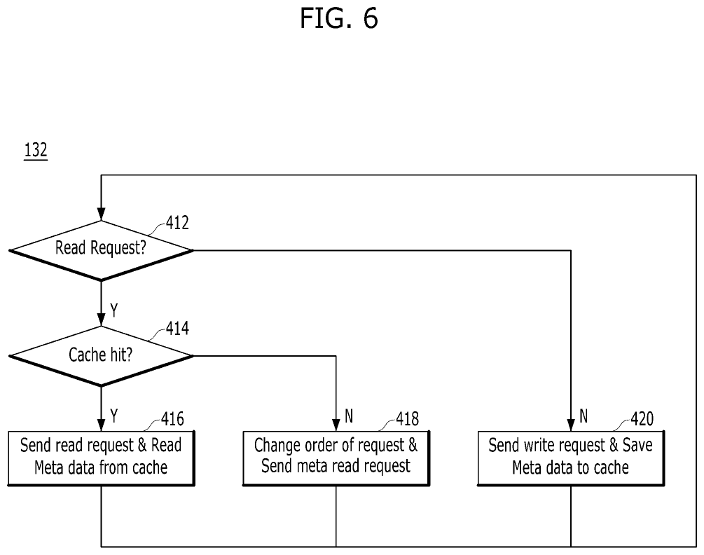

FIG. 6 describes an operation of a scheduler according to an embodiment of the present disclosure.

Referring to FIGS. 3 and 6, the operation of the scheduler 132 can include checking a read request transmitted from at least one of the plurality of hosts 104A, 104B, 104C, 104D (operation 412), and checking whether secondary data associated with the read request is cached and stored in the plurality of buffers (Meta, ECC, ACT Counter, Security) (operation 414).

If a request transmitted from the at least one of the plurality of hosts 104A, 104B, 104C, 104D is not a read request (N in the operation 412), the scheduler 132 can send a write command with user data to the first to fifth logical devices 110A, 110B, 110C, 110D, 110E, and store secondary data associated with the user data in the plurality of buffers (Meta, ECC, ACT Counter, Security) (operation 420).

When the request transmitted from the at least one of the plurality of hosts 104A, 104B, 104C, 104D is the read request (Y in the operation 412), the scheduler 132 can check whether secondary data corresponding to the read request is cached and stored in the plurality of buffers (Meta, ECC, ACT Counter, Security) (operation 414). If the secondary data is stored in the plurality of buffers (Meta, ECC, ACT Counter, Security) (Y in the operation 414), the scheduler 132 can send a first read request for user data to at least one of the first to fifth logical devices 110A, 110B, 110C, 110D, 110E, and read the secondary data stored in the plurality of buffers (Meta, ECC, ACT Counter, Security) (operation 416). If the secondary data is not stored in the plurality of buffers (Meta, ECC, ACT Counter, Security) (N in the operation 414), the scheduler 132 can delay the process or transmission of the first read request for the user data until reading the secondary data from the sixth logical device 110F and caching the read secondary data into the plurality of buffers (Meta, ECC, ACT Counter, Security). A second read request for the reading and caching of the secondary data may be transferred to the sixth logical device 110F (operation 418).

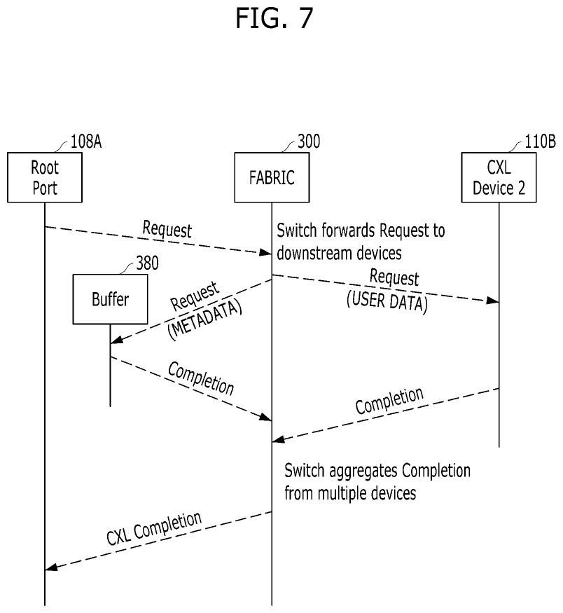

FIG. 7 illustrates a first example of data input/output operations performed in a data processing system according to an embodiment of the present disclosure. Specifically, FIG. 7 describes a write operation in the data processing system.

Referring to FIG. 7, the data processing system may include a root port 108A, a network fabric 300, and a plurality of logical devices 110A, 110B. The network fabric 300 may forward, to the plurality of logical devices 110A, 110B, requests and data transmitted from the root port 108A. A write request with write data may be transmitted to the network fabric 300 from the root port 108A. The network fabric 300 may handle the write request transmitted from the root port 108A by dividing the write data into user data (USER DATA) and secondary data (METADATA) and generate and transmit each request for each data.

The network fabric 300 divides and processes the write data transmitted along with the write request into the user data (USER DATA) and the secondary data (METADATA). The network fabric 380 can transfer a first write request (Request) with the user data (USER DATA) to the second logical device 110B and transfer a second write request (Request) with the secondary data (METADATA) to the buffer 380. When the secondary data (METADATA) is stored in the buffer 380 for each type, a buffer controller may transmit a completion signal (Completion) to the network fabric 300. After the second logical device 110B also stores the user data USER DATA, the second logical device 110B can transmit a completion signal to the network fabric 300. The network fabric 300 may combine the completion signals (Completions) transmitted from the buffer 380 and the second logical device 110B to provide a completion notification (CXL Completion) in response to a write request to the root port 108A. A message delivered by the network fabric 300 to the root port 108A may include a message (e.g., Vendor Defined Message, VDM) in a format tailored to requirements of the root port 108A. The network fabric 300 may transfer the secondary data METADATA stored in the buffer 380 into a logical device other than the second logical device 110B at a preset timing. For example, the preset timing may include a first timing when the buffer 380 is full of the secondary data (METADATA) and a second timing when the network fabric 300 enters an idle state. The network fabric 300 may determine a timing of transferring the secondary data (METADATA) into the logical device other than the second logical device 110B to minimize a burden or an effect on the input/output operations regarding the user data (USER DATA).

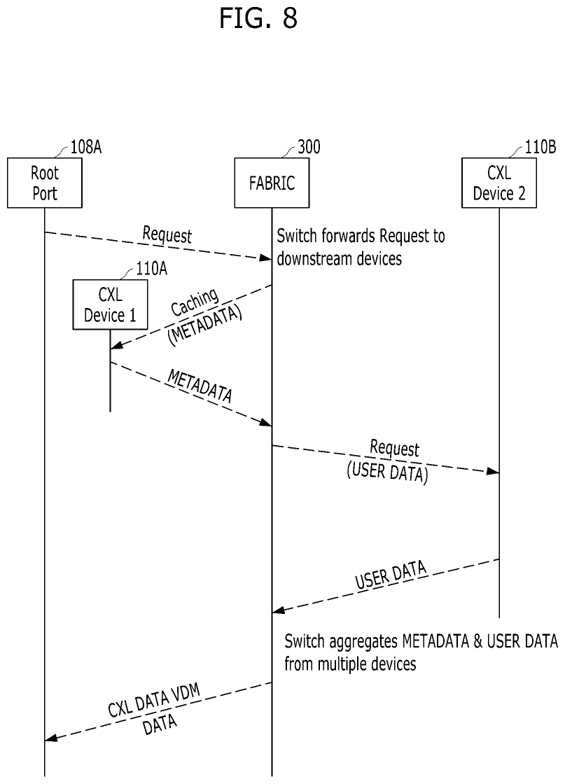

FIG. 8 illustrates a second example of data input/output operations performed in a data processing system according to an embodiment of the present disclosure. Specifically, FIG. 8 describes a read operation in the data processing system.

Referring to FIG. 8, a read request may be transmitted to the network fabric 300 from the root port 108A. The network fabric 300 may handle a read request transmitted from the root port 108A by dividing read data corresponding to the read request into user data (USER DATA) and secondary data (METADATA).

The network fabric 300 may check whether the secondary data related to the user data corresponding to the read request is cached in the buffer 380, in response to the read request. If there is no secondary data in the buffer 380 (i.e., Cache Miss), the network fabric 300 can generate a caching request or a second read request (Caching) for caching the secondary data (METADATA) to the first logical device 110A which is configured to store the secondary data (METADATA). When the secondary data (METADATA) is transmitted from the first logical device 110A, the network fabric 300 may transmit, to the second logical device 110B, a first read request to read the user data (USER DATA). When the first logical device 110A outputs the user data (USER DATA), the network fabric 300 can combine the user data (USER DATA) and the secondary data (METADATA) to transmit the read data (DATA) to the root port 108A.

FIG. 8 describes the case where there is no secondary data in the buffer 380 (Cache Miss), but when there is the secondary data in the buffer 380 (Cache Hit), the network fabric 300 does not have to wait for the secondary data to be obtained or transmitted from the first logical device 110A but transfers the first read request for reading the user data (USER DATA) to the second logic device 110B.

Referring to FIGS. 7 and 8, when a read operation or a write operation is performed in the data processing system using the buffer 380, latencies could be reduced or avoided even though a logical device storing secondary data corresponding to user data has a slower data input/output speed than a logical device storing the user data.

As above described, a data processing system according to an embodiment of the present invention can include a memory device or a memory system having different types of memory cells, different sizes of storage spaces, and different data input/output speeds. The data processing system can allocate or assign a memory device, or a memory system, based on a type or attribute of data.

In addition, the data processing system according to an embodiment of the present invention can divide user data and additional data corresponding to the user data and store the user data and the additional data in memory devices or memory systems having different data input/output speeds, so that usable or available space of the memory device or the memory system may be increased.

In addition, a fabric manager according to an embodiment of the present invention can perform scheduling plural operations for inputting/outputting user data and additional data stored in a memory device or memory system having different data input/output speeds, to control or manage an issue arising from delays caused by different data input/output speed of the memory device or memory system.

Further, a data processing system connected to a plurality of hosts can allocate or release a plurality of memory areas in response to requests from the plurality of hosts, in order to adjust resources available to the plurality of hosts.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods or operations of the computer, processor, controller, or other signal processing device, are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, generators, logic, interfaces, decoders, drivers, generators and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, generators, logic, interfaces, decoders, drivers, generators and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods or operations of the computer, processor, microprocessor, controller, or other signal processing device, are described in detail, the code or instructions for implementing the operations of the method embodiments may transform the computer, processor, controller, or other signal processing device into a special-purpose processor for performing the methods described herein.

While the present teachings have been illustrated and described with respect to the specific embodiments, it will be apparent to those skilled in the art in light of the present disclosure that various changes and modifications may be made without departing from the spirit and scope of the disclosure as defined in the following claims. Furthermore, the embodiments may be combined to form additional embodiments.

What is claimed is:

1. A data processing system comprising:
a plurality of memory devices including a first memory device and a second memory device; and
a fabric instance including a buffer,
wherein the fabric instance is configured to:
receive write data including first data and second data from the at least one host;
store the second data in the buffer;
transfer the first data to the first memory device; and
transfer the second data from the buffer to the second memory device at a preset timing after transferring the first data.

2. The data processing system according to claim 1, wherein the first memory device is configured to operate at a faster data input/output speed than the second memory device.

3. The data processing system according to claim 2, wherein the first memory device comprises a plurality of volatile memory cells, and the second memory device comprises a plurality of non-volatile memory cells.

4. The data processing system according to claim 1,
wherein the second data comprises secondary data, which is associated with the first data and includes metadata, error correction code (ECC) data, security data, and active command count information, and
wherein the buffer comprises a plurality of sub-buffers configured to store therein respective types of data within the secondary data.

5. The data processing system according to claim 4, wherein the plurality of sub-buffers comprises:
a first buffer configured to store the metadata;
a second buffer configured to store the ECC data;
a third buffer configured to store the security data; and
a fourth buffer configured to store the active command count information.

6. The data processing system according to claim 1,
wherein the preset timing comprises a first timing when the buffer is full of the second data and a second timing when the fabric instance enters an idle state, and
wherein the fabric instance comprises:
a scheduler configured to:
transfer a first write request regarding the first data to the first memory device, and
generate a second write request regarding the second data to be transferred to the second memory device at the preset timing; and
hazard control circuitry configured to control, when a read request with a same address as the first write request is input to the fabric instance, the scheduler to keep an order of processing or transmitting the first write request and the read request.

7. The data processing system according to claim 6, wherein the fabric instance further comprises:
a CXL switch comprising at least one virtual peripheral component interconnect (PCI)-PCI bridge (vPPB) and at least one PCI-PCI bridge (PPB); and
a fabric manager configured to control connection between the bridges in the CXL switch.

8. The data processing system according to claim 7, wherein the fabric manager is further configured to control, when at least one sub-buffer included in the buffer is full of the second data, the CXL switch to transfer data from the full sub-buffer to the second memory device.

9. The data processing system according to claim 1, wherein the fabric instance is further configured to:
generate, when a read request for the write data is input from the host, a first read request regarding the first data and a second read request regarding the second data, and
check whether the second data is stored in the buffer before transferring the first and second read requests to the plurality of memory devices.

10. The data processing system according to claim 9, wherein the fabric instance is further configured to:
transfer, when the second data is not stored in the buffer, the second read request to the second memory device, and
transfer the first read request to the first memory device after obtaining the second data from the second memory device in response to the second read request.

11. A fabric manager which controls a switch connected to plural hosts and plural logical devices, the fabric manager comprising:
a buffer configured to store secondary data associated with data stored in the plural logical devices;
a scheduler configured to:
receive a read request transferred from at least one of the plural hosts,
transfer a first read request to a first logical device storing first data included in read data corresponding to the read request,
generate a second read request to be transferred to a second logical device based on whether second data included in the read data is stored in the buffer, and
determine a timing of transferring the first read request based on the generating of the second read request; and
hazard control circuitry configured to control, when a write request with a same address as the read request is input from one of the plural hosts, the scheduler to keep the timing of transferring the first read request.

12. The fabric manager according to claim 11, wherein the first logical device operates at a faster data input/output speed than the second logical device.

13. The fabric manager according to claim 12, wherein the first logical device comprises a plurality of volatile memory cells, and the second logical device comprises a plurality of non-volatile memory cells.

14. The fabric manager according to claim 11,
wherein the second data comprises secondary data, which is associated with the first data and includes metadata, error correction code (ECC) data, security data, and active command count information, and
wherein the buffer comprises a plurality of sub-buffers configured to store therein respective types of data within the secondary data.

15. The fabric manager according to claim 14, wherein the plurality of sub-buffers comprises:
a first buffer configured to store the metadata;
a second buffer configured to store the ECC data;
a third buffer configured to store the security data; and
a fourth buffer configured to store the active command count information.

16. The fabric manager according to claim 11,
wherein the fabric manager is coupled to a CXL switch comprising at least one virtual peripheral component interconnect (PCI)-PCI bridge (vPPB) and at least one PCI-PCI bridge (PPB), and
wherein the fabric manager is further configured to control connection between the bridges in the CXL switch.

17. The fabric manager according to claim 11, wherein the scheduler is configured to:
generate the second read request when the second data is not stored in the buffer; and
transfer the second read request to the second logical device before transferring the first read request.

18. A data processing system comprising:
a plurality of hosts each host comprising a root port;
a plurality of logical devices comprising a plurality of first logical devices storing user data and at least one second logical device storing secondary data associated with the user data; and
a fabric manager configured to:
receive a command for data input/output from the plurality of hosts,
generate plural sub commands for first user data and first secondary data in response to the command, and
store the first secondary data in a buffer or read the first secondary data from the buffer according to a sub command for the first secondary data among the plural sub commands.

19. The data processing system according to claim 18, wherein the plurality of first logical devices is configured to operate at a faster data input/output speed than the at least one second logical device.

20. The data processing system according to claim 18, wherein the secondary data comprises metadata, error correction code (ECC) data, security data, and active command count information, and
wherein the buffer comprises:
a first buffer configured to store the metadata;
a second buffer configured to store the ECC data;
a third buffer configured to store the security data; and
a fourth buffer configured to store the active command count information.
